(19) United States
(12) Patent Application Publication
(10) Pub. No.: US 2007/0118659 A1
(43) Pub. Date: May 24, 2007

(54) Session set-up between two communication entities

(75) Inventors: Renaud Cuny, Espoo (FI); Atte Artamo, Helsinki (FI); Anssi Martikainen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/330,190

(22) Filed: Jan. 12, 2006

(30) Foreign Application Priority Data
Nov. 22, 2005 (EP) 05 025 452.3

(51) Int. Cl. G06F 15/16

(52) U.S. Cl. 709/227; 709/228

(57) ABSTRACT

An improved session set-up between communication entities over a communication network, wherein a communication entity performs the steps of receiving, from a requesting communication entity, a request for setting up a desired session, including desired session attribute information of the requesting communication entity; retrieving matching capability attribute information of the communication entity on the basis of a target application for the desired session; and sending a first response to the requesting communication entity, including the retrieved capability attribute information of the communication entity.

### FIELD OF THE INVENTION

The present invention relates to an improved session set-up between two communication entities over a communication network. In particular, the present invention relates to a method, a communication entity and a computer program product for setting up a session between communication entities, for example a SIP session for a peer-to-peer multimedia application.

### BACKGROUND OF THE INVENTION

In modern communication networks and systems, for example such being based on 3GPP (Third Generation Partnership Project) or IETF (Internet Engineering Task Force) specifications, a multitude of different applications are offered for the users. Many of such applications require creation and management of a session between participating communication entities. In this context, a session is regarded as an exchange of data/content between an association of participants (e.g. communication entities). Examples for various kinds of sessions include unicast sessions and multicast sessions. A session can principally be established in all kinds of networks such as for example wired and wireless data communication networks like the Internet or a cellular network like GSM (Global System for Mobile Communications), WCDMA (Wideband Code Division Multiple Access), GPRS (General Packet Radio Service) or EGPRS (Enhanced GPRS).

In IETF RFC 3261 there is specified a session initiation protocol (SIP), which is an application-layer control protocol for creating, modifying, managing and terminating sessions with one or more participants. Nowadays, SIP is widely used in wired and wireless data communication networks to set up connections/sessions between communication entities serving for example as clients or as client and server. In today's terminals SIP is used by several applications, such as e.g. Video Sharing (VS), Gaming and PoC (Push-to-Talk over Cellular).

SIP supports five facets of establishing and terminating multimedia communications:
user location: determination of the end system (entity) to be used for communication;
user availability: determination of the willingness of the called party to engage in communications;
user capabilities: determination of the media and media parameters to be used;
session set-up: “ringing”, establishment of session parameters at both called and calling party; and
session management: including transfer and termination of sessions, modifying session parameters, and invoking services.

However, especially in wireless and/or cellular communication networks SIP-based functionalities like SIP session set-up tend to be rather slow. This is due to limited processing power in today's terminal equipment. Therefore, launching of applications or processing of SIP messages takes a rather long time, and thus causes some delay in session set-up. Another reason are long channel establishment times in mobile communication environments to transfer (rather short) SIP signaling messages. In this context, it is to be noted that SIP messages typically include also media description that is used between the parties to negotiate media related parameters for the session. Media description may be implemented according to session description protocol (SDP) as specified in IETF RFC 2327. SDP is intended for describing particularly multimedia sessions for the purposes of session announcement, session invitation, and other forms of multimedia session initiation.

According to experience, a set-up of a VS (Video Sharing) multimedia session between two mobile stations in a WCDMA network currently may take over 20 seconds. This is an undesirably long time in terms of time efficiency and user convenience.

In current implementations of terminal equipment, the SIP session set-up cannot proceed until a target application (e.g. a Video Sharing application) in the receiver entity has been successfully launched. One reason is that the target application will specify the media parameters in a SIP reply message.

Another reason resides in the specification of IETF RFC 3264 (“An Offer/Answer Model with the Session Description Protocol”). This document defines a mechanism by which two entities can make use of SDP to arrive at a common view of a multimedia session between them. Here, a common view is to be considered as an agreement of parameters and/or attributes to be used in the session. In this model, one participant offers the other a description of the desired session from its perspective, and the other participant answers the offer with the desired session from its perspective. This offer/answer model is particularly useful in unicast sessions where information from both participants is needed for the complete view of the session. In RFC 3264, it is also specified that the sender of the reply message must be prepared to receive media, or to send and receive media, depending on the type of media stream to be set up. That is, the target application has to be launched right after receipt of a SIP session set-up message, and only after the target application is launched completely, a reply message can be returned.

However, this has an evident disadvantage in that the (latency) time to set up a SIP session is increased significantly because of the wireless devices' limited processing power. For instance, according to recent measurements, the time to launch a Video Sharing application during a SIP Session set-up is about 4 to 5 seconds.

In addition thereto, in case the time to launch the application is larger than radio bearer inactivity timers, then radio resources will be released and will then need to be re-established when the SIP session continues. This further increases the session set-up delay.

In FIG. 1 of the accompanying drawings, there is illustrated an exemplary signaling diagram of a session set-up procedure according to the prior art. The thus illustrated example relates to the set-up of a VS multimedia session in a 3GPP network environment.

In the beginning, terminal A launches a target application (step 1). In the present example, this could be associated with the camera of terminal A being uncovered. Only after that, terminal A is able to set media attributes and send a SIP invitation message “INVITE” to terminal B with which terminal A wishes to establish a multimedia session. In this message, there are included media and session attributes indicating the target application required for the desired session. After having received this invitation message (and having analyzed which target application is needed to be launched), terminal B launches the target application in question (step 3). As mentioned above, this takes about 4 to 5 seconds, during which no further action can be preformed. The launching of the target application can be accompanied by a step of starting application components needed (for example, a camera of terminal B for a video sharing application). Yet, the starting of such application components does not necessarily add further delay, thus being indicated by a dashed block in FIG. 1.

In a fifth step, terminal B responds to terminal A's invitation by sending a reply message. According to a 3GPP mode, the reply message is a “183 SESSION PROGRESS” message according to the SIP specification. In another network environment, the reply message can also be another kind of predefined message, such as e.g. a “180 RINGING” message in IETF mode. In this reply message, media parameters of terminal B are specified. These media parameters may according to SDP specifications include a media type (e.g. video or audio), a transport protocol (e.g. RTP/UDP/IP, i.e. Real-Time Protocol over User Datagram Protocol over Internet Protocol) and a media format (e.g. H.261 video). These media parameters can only be obtained at terminal B after the target application is launched because of being related with the capabilities of the target application at terminal B, and thus not being visible outside this application.

When terminal A receives terminal B's reply message, it responds by sending an acknowledgment message (step 6). Thereby, the session set-up is completed and the media session is set up.

Only after completion of the session setup, terminal A starts respective application components (step 7). That is, the camera itself (uncovered in or before step 1) is actually started. Hereby, a further problem of the prior art is revealed in that application component launches and SIP signaling takes place serially. For example, in case a camera of terminal A for video sharing is started only when the SIP session signaling has already been done. This also adds to the delay time for terminal A being prepared to send and/or receive media data.

In summary, according to known prior art techniques for session set-up there exists a problem in that a session set-up (and in particular a multimedia session set-up) over a communication network (and in particular over a mobile communication network) is a slow process and thus suffers from long delays.

Thus, a solution to the above problems and drawbacks is needed for providing an improved session set-up.

### SUMMARY OF THE INVENTION

Consequently, it is an object of the present invention to remove the above drawbacks inherent to the prior art and to provide an accordingly improved method, communication entity and computer program product.

According to a first aspect of the invention, this object is for example achieved by a method of setting up a session between first and second communication entities over a communication network, wherein a second communication entity performs the steps of:

receiving, from the first communication entity, a request for setting up a desired session, including desired session attribute information of the first communication entity;

retrieving matching capability attribute information of the second communication entity on the basis of a target application for the desired session; and

sending a first response to the first communication entity, including the retrieved capability attribute information of the second communication entity.

According to further advantageous developments and modifications of the present invention:
the step of retrieving retrieves the matching capability attribute information from previously stored capability information of applications supported by the second communication entity;
the previously stored capability information is maintained in the second communication entity;
the previously stored capability information is maintained in an updated manner for every application which has been launched at least once at the second communication entity;
the step of retrieving matching capability information is independent of an operating state of the target application;
the first response further includes an inactive indication indicating that the second communication entity is not prepared for exchanging content relating to the desired session with the first communication entity;
the second communication entity further performs the step of launching the target application for the desired session;
the step of launching the target application further comprises a step of starting application components required for the target application;
the steps of retrieving matching capability attribute information and sending a first response are performed in parallel or prior to the step of launching the target application;
the second communication entity further performs a step of sending a second response to the first communication entity, including an active indication indicating that the second communication entity is prepared for exchanging content relating to the desired session with the first communication entity;
the step of sending a second response is performed after the target application is launched;
the request, the first response and the second response are in accordance with a session initiation protocol, SIP;
the session attribute information is in accordance with a session description protocol, SDP;
the request is a SIP INVITE message;
the first response is a SIP SESSION PROGRESS message;
the first response is a SIP RINGING message;
the session is a multimedia session;
the content exchange in the session is based on a real-time protocol, RTP;
the second response is a RTP dummy packet;
the communication network is a mobile communication network; and/or
the communication network is an Internet Protocol based multimedia subsystem, IMS.

According to a second aspect of the invention, this object is for example achieved by a communication entity being configured for setting up a session with another communication entity over a communication network, comprising:
transceiver means for sending to and receiving from a requesting communication entity,
said transceiver means being configured to receive, a request for setting up a desired session, including desired session attribute information of the requesting communication entity; and
retrieving means for retrieving matching capability attribute information of the communication entity on the basis of a target application for the desired session,
said transceiver means being further configured to send a first response to the requesting communication entity, including the retrieved capability attribute information of the communication entity.

According to further advantageous developments and modifications of the present invention:
the retrieving means is further configured to retrieve the matching capability attribute information from previously stored capability information of applications supported by the communication entity;
the communication entity further comprises storage means for maintaining the previously stored capability information;
the previously stored capability information is maintained in an updated manner for every application which has been launched at least once at said communication entity;
the capability information of a new application is stored upon installation of the new application;
the retrieving means operates independent of an operating state of the target application;
the first response further includes an inactive indication indicating that the communication entity is not prepared for exchanging content relating to the desired session with the requesting communication entity;
the communication entity further comprises application means for launching the target application for the desired session;
the application means is further configured to start application components required for the target application;
the retrieving and transceiver means are configured to retrieve matching capability attribute information and to send a first response in parallel or prior to launching of the target application by the application means;
the transceiver means is further configured to send a second response to the requesting communication entity, including an active indication indicating that the communication entity is prepared for exchanging content relating to the desired session with the requesting communication entity;
the transceiver means is further configured to send the second response after the target application is launched by the application means;
the request, the first response and the second response are in accordance with a session initiation protocol, SIP;
the session attribute information is in accordance with a session description protocol, SDP;
the communication entity is a terminal device;
the communication entity acts as a client entity; and/or
the communication entity acts as a server entity.
   According to a third aspect of the invention, this object is for example achieved by a computer program product being loadable into a memory of a digital processing means of a communication entity and comprising software code portions for performing, when said product is run on said digital processing means, a method of setting up a session between first and second communication entities over a communication network according to the first aspect of the present invention.

It is an advantage of the present invention that it provides for performance improvement features for session set-up.

With the embodiments of the present invention, an advantage of saving significant time for session set-up is provided.

It is another advantage of the present invention that it requires no changes to conventional and/or standardized procedures and only minor changes to conventional equipment. In this regard, it is also advantageous that the embodiments of the present invention comply with and are compatible to previous implementations. That is, no compatibility problems are caused by the embodiments of the present invention.

It is a further advantage of the present invention that performance improvements for session set-up can already be achieved by implementation of the present invention at only one of the two communication entities involved.

### BRIEF DESCRIPTION OF THE DRAWINGS

In the following, the present invention will be described in greater detail with reference to the accompanying drawings, in which

FIG. 1 illustrates an exemplary signaling diagram of a session set-up procedure according to the prior art;

FIG. 2 illustrates an exemplary signaling diagram of a session set-up procedure according to an embodiment of the present invention;

FIG. 3 illustrates an exemplary block diagram of communication entities according to embodiments of the present invention; and

FIG. 4 illustrates another exemplary block diagram of a communication entity according to an embodiment of the present invention in another representation.

### DETAILED DESCRIPTION OF EMBODIMENTS OF THE PRESENT INVENTION

The present invention is described herein with reference to particular non-limiting examples. A person skilled in the art will appreciate that the invention is not limited to these examples, and may be more broadly applied.

In particular, the present invention is described in relation to session set-up in accordance with the SIP and SDP protocols in a 3GPP network environment. As such, the description of the embodiments given herein specifically refers to terminology which is directly related to SIP, SDP and 3GPP. Such terminology is however only used in the context of the presented examples, and does not limit the invention in any way. In particular, the invention as described in the following is as well applicable to any other kind of session set-up procedure and network environment as long as the basic preconditions in terms of e.g. signaling or network architecture are similar.

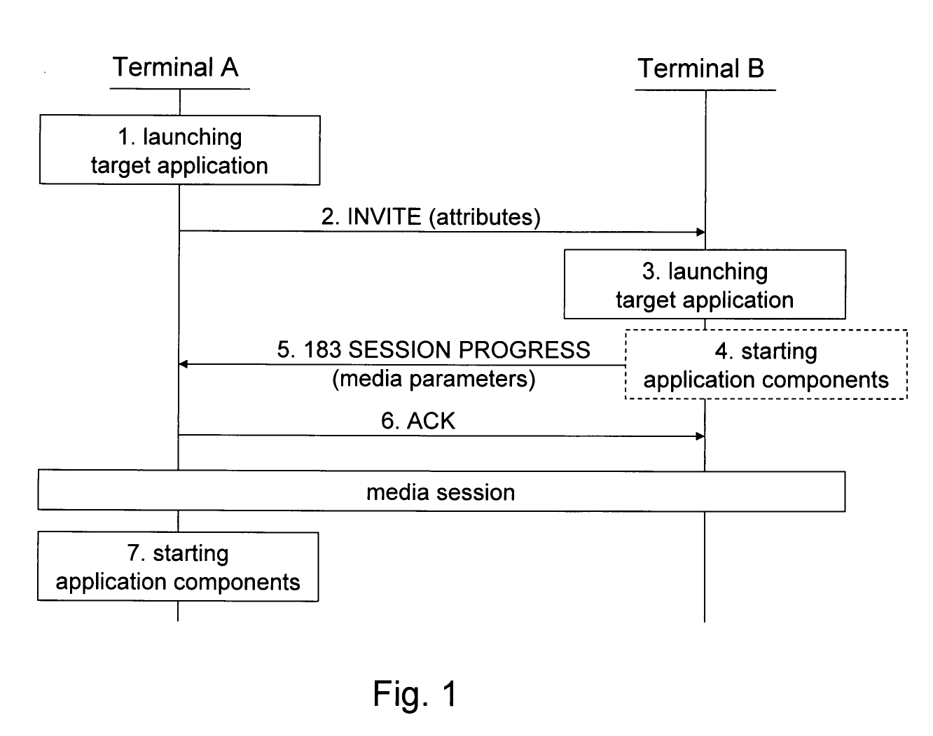

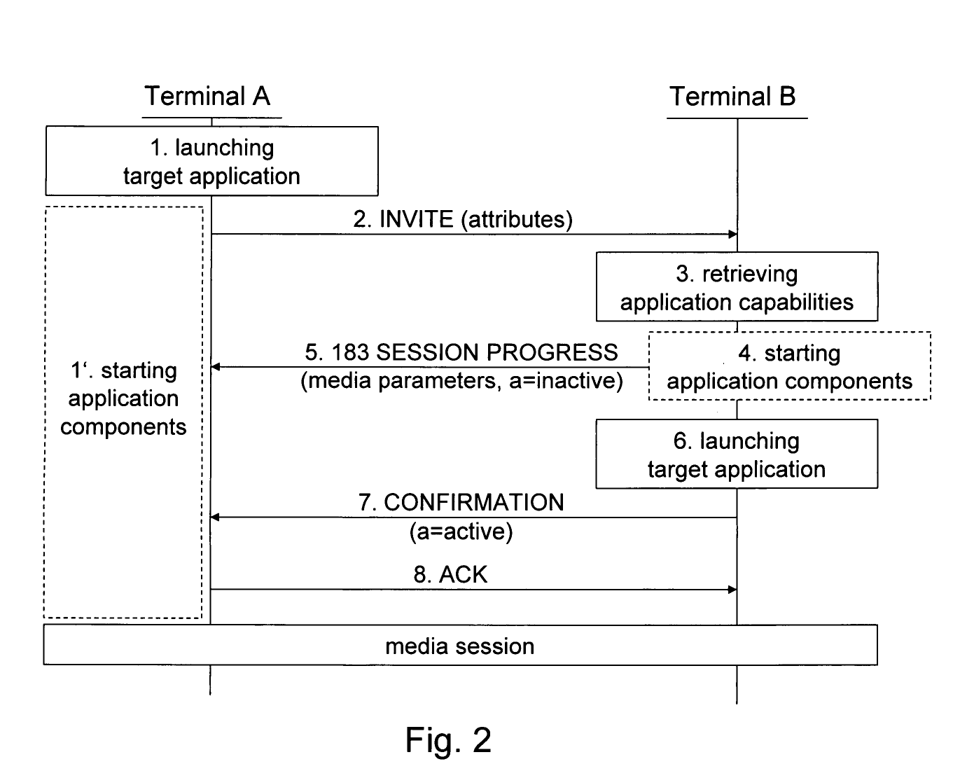

FIG. 2 illustrates an exemplary signaling diagram of a session set-up procedure according to an embodiment of the present invention. In an effort to make clear the differences as compared to conventional techniques, the example underlying FIG. 2 is the same as that of FIG. 1 above, i.e. a set-up of a video sharing multimedia session between terminals A and B in a 3GPP network environment.

Although being evident for a skilled person, it is to be noted that between terminals A and B there is arranged a communication network over which the communication is processed. According to the underlying principles of the present invention, this network is for example a mobile and/or cellular communication network (e.g. GSM, WCDMA, GPRS, EGPRS) or a Third Generation IP-based multimedia subsystem (IMS). In this case, network nodes such as call state control functions (CSCFs) would be arranged between the terminals. Further, in the signaling diagram of FIGS. 1 and 2, there are only illustrated those messages which are relevant for the understanding of the present invention and its embodiments. Other messages according to SIP (such as e.g. TRYING, UPDATE, PRACK) are omitted for the sake of clarity.

In a first step, terminal A launches a target application, e.g. when the camera is uncovered. Then, terminal A again sends a SIP invitation message “INVITE” (i.e. a request) to terminal B (step 2), including session attribute information of terminal A for the desired session. In contrast to FIG. 1, terminal A is according to the present embodiment configured to start required application components of the target application of the desired session immediately after having sent the invitation message, i.e. sometime during the session setup procedure (step 1′).

Thereby, from point of view of the overall set-up procedure and from point of view of terminal B, the time to launch such application components is hid. This is beneficial as the application components, by means of this preparation, are already up and running when the SIP session is completed.

After having received this invitation message (and having analyzed which target application is required), terminal B—in contrast to FIG. 1—does not launch the target application at this point of time (i.e. after receiving “INVITE”), thus saving time before sending a reply message (i.e. a first response) to terminal A.

Rather, terminal B immediately generates an SDP answer based on the target application capability (media parameters supported etc). Namely, it retrieves capability attribute information regarding the target application in question (step 3). The capability attribute information to be retrieved are those that (best) match the desired session attribute information of the invitation message from terminal A. To this end, a common view of both participating communication entities can be “agreed” on.

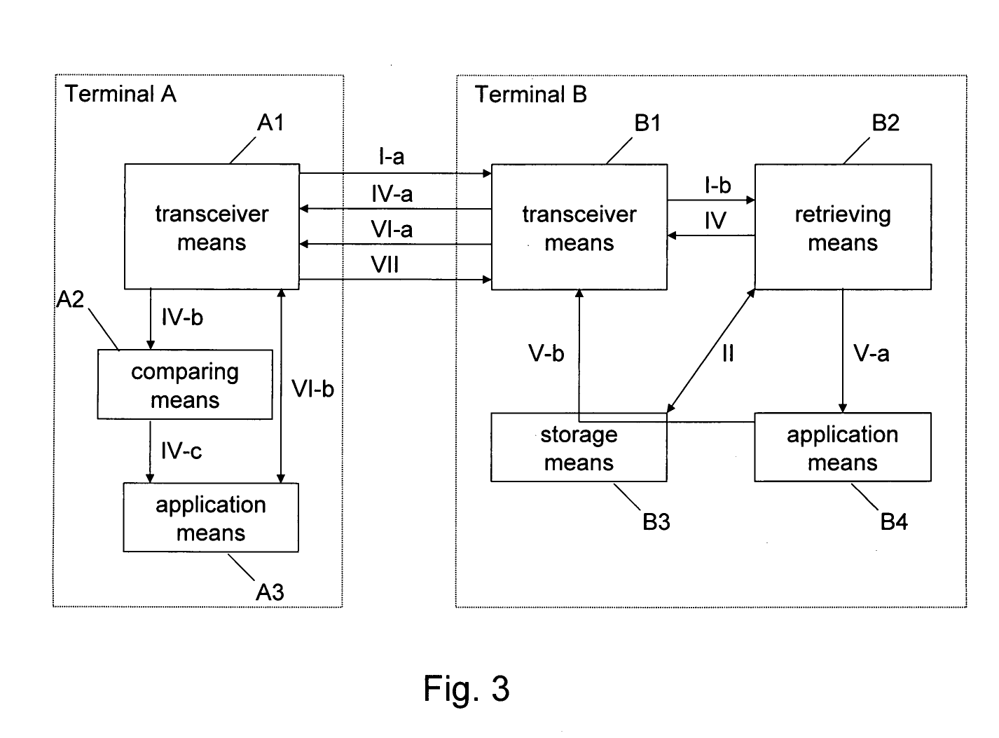

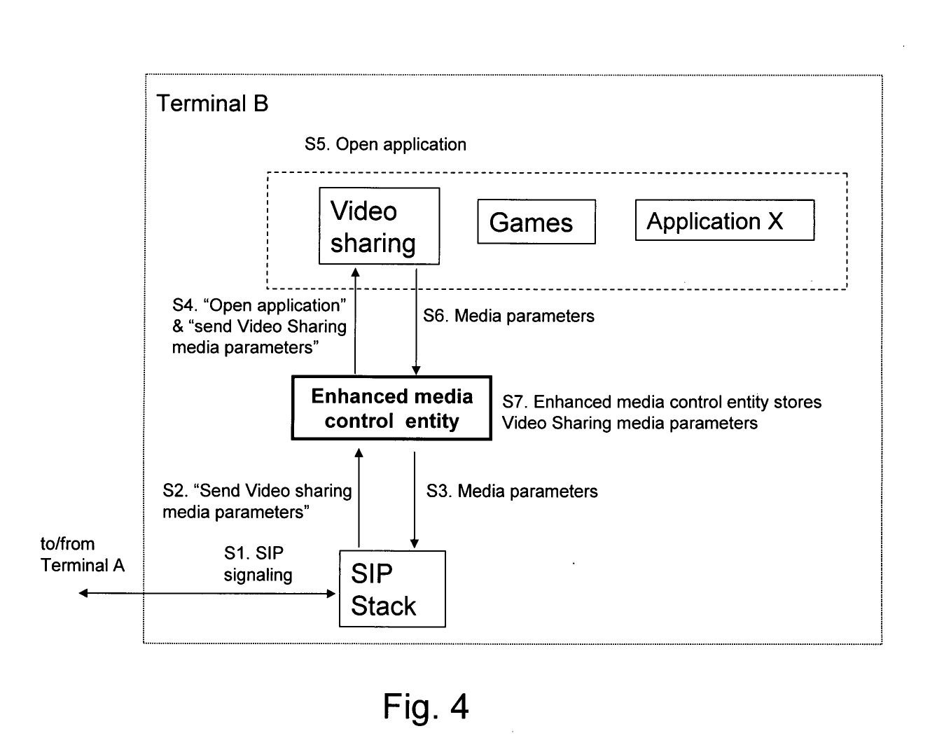

To allow terminal B (receiver) to send a SIP reply message (that includes the first SDP answer) to terminal A (sender) although the target application is not up and running, the information related to media supported by the application is to be visible outside of it. In the underlying example, when a VS (video sharing) session is desired by terminal A to be set up, terminal B retrieves the respective capabilities which are supported by its own VS application, for example media type, transport protocol and media format. This requires that the related information is available at a lower layer (e.g. SIP) or in some independent functional entity. Theretofore, the respective information is according to the present embodiment stored in an independent functional entity within terminal B, which maintains all required information concerning media parameters and capabilities for all peer-to-peer multimedia applications supported in the terminal, and which can be queried independent of the target application running or not (cf. FIGS. 3 and 4). For instance, the needed capability attribute information could be obtained and stored when the respective application is installed or launched for the first time in this terminal. Accordingly, every application would also require to refresh that information stored.

In case that no matching capability attribute information is available, the procedure continues in accordance with the prior art, i.e. the target application has to be launched before replying to the invitation message.

Optionally, but independent of the further signaling procedure, terminal B according to the present embodiment is also configured to start application components (e.g. a camera for a video sharing application) already after having received the invitation message, and not only after the target application is launched (step 4).

As soon as the required capabilities of the target application, which are supported by terminal B, have been retrieved, terminal B is enabled to send a reply message to terminal A, in which the retrieved matching attribute information is included. In the illustrated example, the reply message of step 5 is a SIP message “183 SESSION PROGRESS” (but could in accordance with an IETF network environment also be a SIP message “180 RINGING”). As can be gathered from step 5 of FIG. 2, the reply message besides the media parameters as retrieved also includes an inactive indication indicating that terminal B is not yet prepared for exchanging data relating to the desired session with terminal A, because the target application is not yet launched (for saving processing time).

According to an embodiment of the present invention, such an indication can be made by means of a session attribute field for media-level attributes, which is a predefined field in a media description part of SDP messages, and thus is in accordance with IETF RFC 2327 and RFC 3264, as mentioned above.

When receiving the reply message “183 SESSION PROGRESS”, terminal A knows the media parameters which terminal B intends to use. Terminal A has already launched the target before sending the first INVITE message (step 1). In view of the inactive indication in the reply message, terminal A is aware that it can not yet send media data to terminal B. Accordingly, terminal A does not acknowledge the session set-up completion, but sends a PRACK message (not shown) as usually and/or awaits a further confirmation (i.e. a second response) from terminal B, indicating that terminal B is ready.

In parallel with sending the reply message to terminal A, terminal B launches the target application at its side (step 6). Once the target application is launched successfully, terminal B is in a position to send a confirmation message (as awaited by terminal A) to notify terminal A that it is now ready to send and/or receive media (in dependence on the type of media stream to be set up). This notification is accomplished by an active indication e.g. by means of a session attribute field for media-level attributes, as mentioned above in connection with the inactive indication.

Another alternative according to an embodiment of the present invention (not shown in FIG. 2) is that terminal A waits for a first RTP (Real-Time Protocol) dummy packet sent by terminal B. If configured accordingly, terminal A is aware of terminal B being ready to send and/or receive media when receiving such a RTP dummy packet sent by terminal B in such an accordingly embodied implementation to allow the media stream to start.

It is to be noted that RTP dummy packets are used in previous implementations to open up a firewall to the receiver access network (i.e. to be able to get access to terminal A). But in the respective embodiment of the present invention, this RTP dummy packet also serves as an indication to the sender (i.e. terminal A) that the receiver's (i.e. terminal B's) application is up and running. This would even be an easily implementable solution to let A know that B is ready to receive data.

After receiving an active indication from terminal B (whether in a confirmation message such as e.g. “200 OK” or in a RTP dummy packet), terminal A responds with sending an acknowledgment message in step 8, thus completing the session set-up.

Thus, the early reply procedure as set out above allows the SIP session set-up to proceed in parallel with the launch of the target application and to save significant time in the session set-up procedure.

Although the present invention has been described above mainly with reference to the respective method steps, it is to be understood that the present invention also relates to a respective computer program product for carrying out these method steps at terminal B as well as to respective communication entities representing terminals A and B. Details thereof are set forth in the following.

FIG. 3 illustrates an exemplary block diagram of communication entities according to embodiments of the present invention. Thus, by means of FIG. 3, there is also disclosed a system according to an embodiment of the present invention, including a first communication entity denoted by terminal A and a second communication entity denoted by terminal B. The network in between these terminal is gain omitted for the sake of clarity.

According to the present invention, the terminals can act as client-client or client-server arrangements.

In order not to be confused with the numbering of preceding figures, the processing sequence in FIG. 3 is indicated by roman numbers (which in value largely correspond to the respective Arabic numbers in FIGS. 1 and 2).

According to the illustrated exemplary embodiment, a second communication entity denoted by terminal B comprises transceiver means B1, retrieving means B2, storage means B3 and application means B4, wherein there may exist one application means for each application supported by terminal B or one application means for all supported applications. The transceiver means B1 is for sending to and receiving from the first communication entity denoted by terminal A. In particular, the transceiver means B1 is configured to receive an invitation message I-a for setting up a desired session and/or an acknowledgment message VII, and to send a reply message IV-a including retrieved capability attribute information of terminal B and/or a confirmation message VI-a. The retrieving means B2 is configured to retrieve, on the basis of the invitation message I-b forwarded thereto by the transceiver means, matching capability attribute information of terminal B based on the target application for the desired session. The retrieving means is further configured to perform the retrieving (denoted by II) from previously stored capability information, i.e. from the storage means B3.

After the retrieval the retrieving means generates a respective media description (e.g. SDP) containing the retrieved information and forwards (denoted by IV) this media description to the transceiver means for being sent to terminal A as a reply message IV-a.

In parallel thereto, the application means B4 is triggered (for example by the retrieving means B2) to launch the target application. For this purpose, the retrieving means B2 also notifies the application means B4 on which application to be launched (see V-a). The application means B4 can further be configured to start application components required for the target application, as mentioned above. After having launched the target application, the application means B4 notifies the transceiver means B1 accordingly (see V-b). In doing so, it is checked whether this application has been installed or launched for the first time in terminal B, or whether the application has been updated since the last launch. In this case, respective (new or updated) capability attribute information are stored in the storage means B3 for being maintained therein. (This is indicated in FIG. 3 in that the arrow denoted by V-b proceeds from the application means B4 to the transceiver means B1 via the storage means B3.) Thereby, the stored capability information are always kept in an up-to-date condition.

Upon receipt of the launch indication from the application means B4, the transceiver means B1 is configured to send a confirmation message VI-a to terminal A, thus being indicated that terminal B is now prepared to actively join the session to be set up.

According to the illustrated exemplary embodiment, a first communication entity denoted by terminal A comprises transceiver means A1, comparing means A2 and application means A3. The transceiver means A1 is for sending to and receiving from the second communication entity denoted by terminal B. In particular, the transceiver means B1 is configured to send an invitation message I-a for setting up a desired session and/or an acknowledgment message VII, and to receive a reply message IV-a including the retrieved capability attribute information of terminal B and/or a confirmation message VI-a. The comparing means A2 is configured to compare, upon receipt of a reply message IV-a from terminal B, the desired session attribute information for the desired session with the received capability attribute information (denoted by IV-b). Thus, it is checked at terminal A, whether and, if yes, how a session may be set up with terminal B on the basis of the media parameters agreed on. This information is fed to the application means A3 (see IV-c). The application means is configured to start application components required for the target application, e.g. after the invitation message I-a is sent.

After receiving the confirmation message VI-a from terminal B, terminal A knows that the media session is about to start and thus gives an respective advice to the application means (see VI-b), whereupon the acknowledgment message VII is returned to terminal B.

Thus, stated in general terms, the communication entities are configured to perform any of the methods of setting up a session between first and second communication entities over a communication network, as described throughout this description and/or the claims.

FIG. 4 illustrates another exemplary block diagram of a communication entity according to an embodiment of the present invention in another representation, i.e. the second communication entity hereinbefore denoted by terminal B.

The representation of FIG. 4 represents a more functional structure as compared to FIG. 3. In comparison, the transceiver means B1 of FIG. 3 basically corresponds to the SIP stack of FIG. 4, the retrieving and storing means B2/B3 of FIG. 3 basically correspond to the enhanced media control entity of FIG. 4, and the application means B4 of FIG. 3 basically correspond t the collectivity of video sharing, games and application X, which are intended to represent the target applications of terminal B. The enhanced media control entity of FIG. 4 can be regarded as a new or enhanced entity of terminal B, which maintains media capabilities on behalf of the applications, and which interfaces the SIP stack and the applications as such.

According to FIG. 4, it can be gathered that during SIP signaling for SIP session setup (step S1), media parameters are supplied to the SIP stack (step S3) right after a command for sending VS media parameters to the enhanced media control entity in step S2. Only after that, a command for opening an appropriate application and sending VS media parameters is sent to the respective application (video sharing in this example), the application is opened, and the media parameters are supplied to and stored in the enhanced media control entity in steps 6 and 7, if required. As mentioned above, steps 6 and 7 are optional and thus omissible in case the enhanced media control entity already knows the media parameters.

In general, it is also to be noted that the mentioned functional elements, e.g. retrieving means according to the present invention can be implemented by any known means, either in hardware and/or software, respectively, if it is only adapted to perform the described functions of the respective parts. For example, the retrieving means of the second communication entity can be implemented by any data processing unit, e.g. a microprocessor, being configured to retrieve matching capability attribute information of the second communication entity on the basis of a target application for the desired session, as defined by the appended claims. The mentioned parts can also be realized in individual functional blocks or by individual devices, or one or more of the mentioned parts can be realized in a single functional block or by a single device. Correspondingly, the above illustration of FIG. 3 is only for illustrative purposes and does not restrict an implementation of the present invention in any way.

Furthermore, method steps likely to be implemented as software code portions and being run using a processor at one of the peer entities are software code independent and can be specified using any known or future developed programming language such as e.g. C, C++, and Assembler. Method steps and/or devices or means likely to be implemented as hardware components at one of the peer entities are hardware independent and can be implemented using any known or future developed hardware technology or any hybrids of these, such as MOS, CMOS, BiCMOS, ECL, TTL, etc, using for example ASIC components or DSP components, as an example. Generally, any method step is suitable to be implemented as software or by hardware without changing the idea of the present invention. Devices and means can be implemented as individual devices, but this does not exclude that they are implemented in a distributed fashion throughout the system, as long as the functionality of the device is preserved. Such and similar principles are to be considered as known to those skilled in the art.

In summary, there is presented an improved session set-up between communication entities over a communication network, wherein a communication entity performs the steps of receiving, from a requesting communication entity, a request for setting up a desired session, including desired session attribute information of the requesting communication entity; retrieving matching capability attribute information of the communication entity on the basis of a target application for the desired session; and sending a first response to the requesting communication entity, including the retrieved capability attribute information of the communication entity.

Even though the invention is described above with reference to the examples according to the accompanying drawings, it is clear that the invention is not restricted thereto. Rather, it is apparent to those skilled in the art that the present invention can be modified in many ways without departing from the scope of the inventive idea as disclosed in the appended claims.

1. A method of setting up a desired session between first and second communication entities over a communication network, wherein the second communication entity performs the steps of:
receiving, from the first communication entity, a request for setting up the desired session, including desired session attribute information of the first communication entity;
retrieving matching capability attribute information of the second communication entity on the basis of a target application for the desired session; and
sending a first response to the first communication entity, including the retrieved capability attribute information of the second communication entity.

2. The method according to claim 1, wherein the step of retrieving further comprises a step of:
retrieving the matching capability attribute information from previously stored capability information of applications supported by the second communication entity.

3. The method according to claim 2, further comprising the step of:
maintaining the previously stored capability information in the second communication entity.

4. The method according to claim 2, further comprising the step of:
maintaining the previously stored capability information in an updated manner for every application which has been launched at least once at the second communication entity.

5. The method according to claim 1, wherein the step of retrieving matching capability information is independent of an operating state of the target application.

6. The method according to claim 1, further comprising the step of:
configuring in the first response an inactive indication indicating that the second communication entity is not prepared for exchanging content relating to the desired session with the first communication entity.

7. The method according to claim 1, wherein the second communication entity further performs the step of:
launching the target application for the desired session.

8. The method according to claim 7, wherein the step of launching the target application further comprises a step of:
starting application components required for the target application.

9. The method according to claim 7, further comprising the step of:
performing the steps of retrieving matching capability attribute information and sending a first response in parallel or prior to the step of launching the target application.

10. The method according to claim 7, wherein the second communication entity further performs a step of:
sending a second response to the first communication entity, including an active indication indicating that the second communication entity is prepared for exchanging content relating to the desired session with the first communication entity.

11. The method according to claim 10, further comprising the step of:
performing the step of sending a second response after the target application is launched.

12. The method according to claim 1, wherein the request, the first response and the second response are in accordance with a session initiation protocol, SIP.

13. The method according to claim 12, wherein the session attribute information is in accordance with a session description protocol, SDP.

14. The method according to claim 12, wherein the request is a SIP INVITE message.

15. The method according to claim 12, wherein the first response is a SIP SESSION PROGRESS message.

16. The method according to claim 12, wherein the first response is a SIP RINGING message.

17. The method according to claim 1, wherein the desired session is a multimedia session.

18. The method according to claim 17, wherein the content exchange in the desired session is based on a real-time protocol, RTP.

19. The method according to claim 10, wherein the second response is a RTP dummy packet.

20. The method according to claim 1, wherein the communication network is a mobile communication network.

21. The method according to claim 1, wherein the communication network is an Internet Protocol based multimedia subsystem, IMS.

22. A communication entity being configured for setting up a desired session with another communication entity over a communication network, comprising:
transceiver means for sending to and receiving from a requesting communication entity;
said transceiver means being configured to receive, a request for setting up the desired session, including desired session attribute information of the requesting communication entity; and
retrieving means for retrieving matching capability attribute information of the communication entity on the basis of a target application for the desired session, and
said transceiver means being further configured to send a first response to the requesting communication entity, including the retrieved capability attribute information of the communication entity.

23. The communication entity according to claim 22, wherein the retrieving means is further configured to retrieve the matching capability attribute information from previously stored capability information of applications supported by the communication entity.

24. The communication entity according to claim 23, further comprising:
storage means for maintaining the previously stored capability information.

25. The communication entity according to claim 23, wherein the previously stored capability information is maintained in an updated manner for every application which has been launched at least once at said communication entity.

26. The communication entity according to claim 25, wherein the capability information of a new application is stored upon installation of the new application.

27. The communication entity according to claim 22, wherein the retrieving means operates independent of an operating state of the target application.

28. The communication entity according to claim 22, wherein the first response further includes an inactive indication indicating that the communication entity is not prepared for exchanging content relating to the desired session with the requesting communication entity.

29. The communication entity according to claim 22, further comprising:
application means for launching the target application for the desired session.

30. The communication entity according to claim 29, wherein the application means is further configured to start application components required for the target application.

31. The communication entity according to claim 29, wherein the retrieving and transceiver means are configured to retrieve matching capability attribute information and to send a first response in parallel or prior to launching of the target application by the application means.

32. The communication entity according to claim 29, wherein the transceiver means is further configured to send a second response to the requesting communication entity, including an active indication indicating that the communication entity is prepared for exchanging content relating to the desired session with the requesting communication entity.

33. The communication entity according to claim 32, wherein the transceiver means is further configured to send the second response after the target application is launched by the application means.

34. The communication entity according to claim 22, wherein the request, the first response and the second response are in accordance with a session initiation protocol, SIP.

35. The communication entity according to claim 34, wherein the session attribute information is in accordance with a session description protocol, SDP.

36. The communication entity according to claim 22, wherein the communication entity is a terminal device.

37. The communication entity according to claim 22, wherein the communication entity acts as a client entity.

38. The communication entity according to claim 22, wherein the communication entity acts as a server entity.

39. A computer program embodied in a computer-readable medium comprising program code configured to set-up a desired session between first and second communication entities over a communication network, the computer program being configured to perform the steps of:
receiving, from the first communication entity, a request for setting up the desired session, including desired session attribute information of the first communication entity;
retrieving matching capability attribute information of the second communication entity on the basis of a target application for the desired session; and
sending a first response to the first communication entity, including the retrieved capability attribute information of the second communication entity.
